(19) United States
(12) Patent Application Publication
(10) Pub. No.: US 2013/0134319 A1
(43) Pub. Date: May 30, 2013

(54) MECHANICAL SHOCK ISOLATION FOR A RADIOGRAPHIC DEVICE

(71) Applicants: Nicholas Ryan Konkle, Waukesha, WI (US); Habib Vafi, Brookfield, WI (US); Christopher Jay Morse, North Prairie, WI (US); Kevin Edward Kinsey, Waukesha, WI (US)

(72) Inventors: Nicholas Ryan Konkle, Waukesha, WI (US); Habib Vafi, Brookfield, WI (US); Christopher Jay Morse, North Prairie, WI (US); Kevin Edward Kinsey, Waukesha, WI (US)

(73) Assignee: General Electric Company, Schenectady, NY (US)

(21) Appl. No.: 13/308,369

(22) Filed: Nov. 30, 2011

(51) Int. Cl. G01T 1/16; G01T 7/00

(52) U.S. Cl. 250/394; 150/154

(57) ABSTRACT

A portable radiation detector is described having various shock isolation features. In one embodiment, shock isolation may be provided by providing a non-rigid mounting for a support layer within the portable detector to an enclosure of the portable detector. In other embodiments, an elastomeric strip is provided about all or part of an edge of the enclosure. In other embodiments, a removable elastomeric cover is provided for the portable detector.

### BACKGROUND

A number of non-invasive imaging approaches are known and are presently in use. One such type of system is based upon the detection of X-rays or other radiation that has passed through a volume of interest. The radiation traverses the volume, and whatever materials occupy the volume, and impact a film or a digital detector. In medical diagnostic contexts, for example, such systems may be used to visualize internal tissues and diagnose patient ailments. In other contexts, parts, baggage, parcels, and other materials may be imaged to assess their contents or for other purposes, such as for quality review in a manufacturing context.

Increasingly, such non-invasive imaging or inspection systems use digital circuitry, such as solid-state detectors, for detecting the radiation of interest. Such solid-state detectors may generate electrical signals indicative of the incident radiation on the detector, which in turn is indicative of the attenuation or scatter of the radiation along different ray paths through the imaged volume. The generated signals may in turn be processed to reconstruct images of the subject or object of interest within the volume, including internal features of an object or patient within the imaged volume.

Such solid-state or digital detectors may be portable and may be used in place of older detection systems (including film based detection systems) as a means of upgrading an existing system. In addition, in newer systems, a variety of portable detectors may be provided and used interchangeably with different systems, such that no one detector is fixed to or dedicated for use with a particular imaging system.

One drawback to a detector being portable and transportable is that the detector becomes subject to being dropped or damaged while being moved about a facility or between inspection or imaging locations. Further, to the extent that a portable digital detector is designed as a replacement for an existing detector implementation, the portable digital detector may be designed to conform to a form-factor or industry standard size associated with the existing detection scheme. In such a context, the space available within the detector to provide shock absorption or other physical protection of internal components may be limited due to adherence to the standardized size or shape of detector system being replaced.

### BRIEF DESCRIPTION

In accordance with one embodiment, a portable radiation detector is provided. The portable radiation detector comprises an enclosure, a support layer comprising a plurality of mounting holes, and a respective elastomeric structure positioned within each mounting hole. In addition, the portable radiation detector comprises a respective fastener positioned within each elastomeric structure and secured to the enclosure such that the support layer is fastened to the enclosure. A detector array is mounted on the support layer and readout electronics communicatively coupled to the detector array.

In accordance with a further embodiment, a portable radiation detector is provided. The portable radiation detector comprises an enclosure and an elastomeric strip disposed around at least a portion of an outer perimeter of the enclosure. In addition, the portable radiation detector comprises a support layer fastened to the enclosure, a detector array mounted on the support layer, and readout electronics communicatively coupled to the detector array.

In accordance with an additional embodiment, a cover for a portable radiation detector is provided. The cover comprises an elastomeric cover configured to be removably applied to an enclosure of a portable radiation detector. The elastomeric cover, when applied, covers at least a portion of an outer perimeter of the enclosure.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a diagrammatical overview of a digital radiation detection system in accordance with one or more embodiments of the present disclosure;

FIG. 2 is a perspective view of a portable digital detector, in accordance with aspects of the present disclosure;

FIG. 3 depicts a cutaway plan view of internal components of a portable detector, in accordance with aspects of the present disclosure;

FIG. 4 depicts a cutaway side view of an edge of a portable detector, in accordance with aspects of the present disclosure;

FIG. 5 depicts an exploded view of an attachment region of the portable detector of FIG. 4;

FIG. 6 depicts a cutaway side view of an edge of a portable detector, in accordance with further aspects of the present disclosure;

FIG. 7 depicts a cutaway perspective view of a portable detector in accordance with aspects of the present disclosure;

FIG. 8 depicts a perspective view of a portable detector in accordance with further aspects of the present disclosure; and

FIG. 9 depicts a perspective view of a portable detector in accordance with additional aspects of the present disclosure.

### DETAILED DESCRIPTION

When introducing elements of various embodiments of the present disclosed subject matter, the articles “a,” “an,” “the,” and “said” are intended to mean that there are one or more of the elements. The terms “comprising,” “including,” and “having” are intended to be inclusive and mean that there may be additional elements other than the listed elements. Moreover, while the term “exemplary” may be used herein in connection to certain examples of aspects or embodiments of the presently disclosed technique, it will be appreciated that these examples are illustrative in nature and that the term “exemplary” is not used herein to denote any preference or requirement with respect to a disclosed aspect or embodiment. Further, any use of the terms “top,” “bottom,” “above,” “below,” other positional terms, and variations of these terms is made for convenience, but does not require any particular orientation of the described components.

As discussed herein, portable digital radiation detectors (such as detectors suitable for detecting X-rays, gamma rays, radioactive isotopes, and so forth) may be provided with different forms and degrees of mechanical shock protection. In particular, a portable detector as discussed herein may be subject to various size constraints, such as when the portable detector is constructed to replace an existing size class or category of detection systems, such as film-based detector cassettes in one example. However, even when not envisioned as a replacement for existing detector systems, it may be desirable to construct the portable detector to be as thin as possible and/or to minimize the distance between the edge and active area of the portable detector (i.e., to maximize the surface area available for radiation detection).

However, there may be a tradeoff between these desirable size constraints and the ruggedness of the portable detector. Indeed, due to the portable nature of the detector, it may be desirable to construct the portable detector such that it is sufficiently rugged to survive the mechanical shock of being dropped from a height typically associated with use or transport, e.g., 3-5 feet. However, since motion is typically associated with mechanical shock absorption (i.e., the components being protected should move relative to the external enclosure or housing in some way), the limited space envelope associated with a portable detector may constrain the ability to provide mechanical shock absorption. The various implementations of portable detectors discussed herein address one or more of these challenges.

In particular, one or more specific embodiments of a mechanically rugged portable detector will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

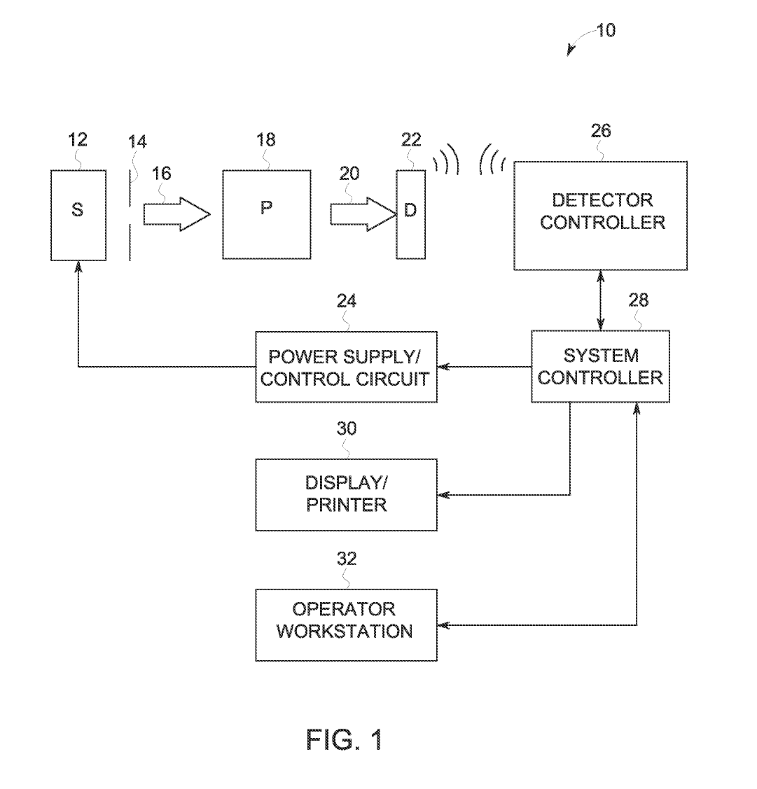

With the foregoing comments in mind and turning to FIG. 1, this figure illustrates diagrammatically an example of an imaging or inspection system 10 for non-invasively acquiring and subsequently processing data related to incident radiation on a portable detector, such as mechanically rugged portable detector, as discussed herein. In the illustrated embodiment, the system 10 is an X-ray based system designed both to acquire original image data and to process the image data for display. Though an X-ray based imaging system is discussed by way of example and to simplify explanation, in other implementations, other types of radiation of radioactive isotopes (such as gamma rays) may be measured or detected using a portable detector as discussed herein.

In the embodiment illustrated in FIG. 1, system 10 includes a source 12 of radiation, such as an X-ray tube, positioned adjacent to a collimator 14 that shapes and/or limits a stream of radiation 16 that passes into a region in which an object or subject, such as a patient 18, is positioned. In other embodiments, the source 12 of radiation 12 may be a radioactive isotope or other radiation emitter and structures such as collimator 14 may or may not be present to shape the emitted radiation stream.

A portion of the radiation 20 passes through or around the subject and impacts a portable digital radiation detector, represented generally at reference numeral 22. In the context of an X-ray based imaging or inspection system, the portable detector 22 may convert the X-ray photons incident on its surface to lower energy photons, and subsequently to electric signals, which are acquired and processed to reconstruct an image of the features within the subject. In other radiation detection contexts, the incident radiation may be converted to lower energy photons that may then be detected or, in a direct conversion implementation, the incident radiation itself may be measured without an intermediary conversion process.

In one example of an imaging or inspection system 10, the source 12 of radiation is a controlled source, which may be powered and/or controlled by a power supply/control circuit 24 which supplies both power and control signals for examination sequences. An example of one such controlled implementation is depicted in FIG. 1. In other implementations, the source 12 of radiation may not be a controlled source, but may instead be an uncontrolled source 12, such as a radioactive isotope or other source of radiation that is not powered and/or controlled directly.

In one example, the portable detector 22 is communicatively coupled to a detector controller 26 which commands acquisition of the signals generated in the portable detector 22. In the depicted example, the portable detector 22 communicates wirelessly with the detector controller 26 via a suitable wireless communication standard. In other embodiments, the portable detector 22 can communicate with the detector controller 26 over a wire or cable. In one implementation, the detector controller 26 may be implemented on a laptop computer or other suitable processor-based system suitable for communicating with the portable detector 22. For example, in certain implementations the detector controller 26 and/or other components of the system 10 may be implemented on or as part of a processor-based system, such as a desktop, laptop, or tablet computer platform.

In one embodiment, the detector controller 26 may be a handheld device or controller that allows a user to control operation of the portable detector 22, such as to place the detector 22 in a receptive state where incident radiation on the detector 22 may be measured or in a standby or idle state when an image operation is not currently being performed or is not imminent. In such implementations, the detector controller 26 may be controlled by a user, without further communication with the other components of the system 10. In other embodiments, the detector controller 26 may communicate with a system controller 28 and/or other components of the system 10, discussed below, to coordinate operation and readout of the portable detector 22 with the operation of the other components of the system 10.

In implementations in which a controlled source 12 is present, the respective power supply/control circuit 24 is responsive to signals from a system controller 28. In some implementations, the detector controller 26 may also be responsive to signals from the system controller 28. In general, the system controller 28 commands operation of the system 10 to execute examination protocols and, in some instances, to process acquired image data. For example, in some embodiments the system controller 28 may include signal processing circuitry, typically based upon a programmed general purpose or application-specific digital computer; and associated manufactures, such as optical memory devices, magnetic memory devices, or solid-state memory devices, for storing programs and routines executed by a processor of the computer to carry out various functionalities, as well as for storing configuration parameters and image data; interface protocols; and so forth. In one embodiment, a general or special purpose computer system may be provided with hardware, circuitry, firmware, and/or software for performing the functions attributed to one or more of the power supply/control circuit 24, the detector controller 26, and/or the system controller 28 as discussed herein.

In the embodiment illustrated in FIG. 1, the system controller 28 is linked to at least one output device, such as a display or printer as indicated at reference numeral 30. The output device may include standard or special purpose computer monitors and associated processing circuitry. One or more operator workstations 32 may be included in or otherwise linked to the system for outputting system parameters, requesting examinations, viewing images, and so forth. In general, displays, printers, workstations, and similar devices supplied within the system may be local to the data acquisition components, or may be remote from these components, such as elsewhere within an institution or hospital, or in an entirely different location, linked to the image acquisition system via one or more configurable networks, such as the Internet, virtual private networks, and so forth.

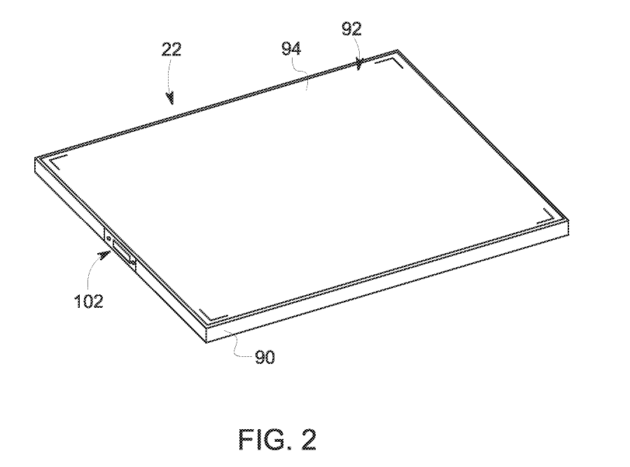

With the foregoing discussion of imaging systems in mind, it should be appreciated that such systems may be used in conjunction with a portable detector 22, as discussed herein. One example of an embodiment of a portable detector 22 is generally illustrated in FIG. 2. In the illustrated embodiment, the portable detector 22 may include an enclosure 90, e.g., a housing, which encloses various components of the detector 22. In certain embodiments, the enclosure 90 includes a window 92 that exposes a surface of the solid-state detector array 94 on which radiation is directed during use. As discussed above, when in use, the detector array 94 may be configured to receive electromagnetic radiation, such as from the radiation source 12, and to convert the radiation into electrical signals that may be interpreted by the system 10 to output an image of an object or patient 18.

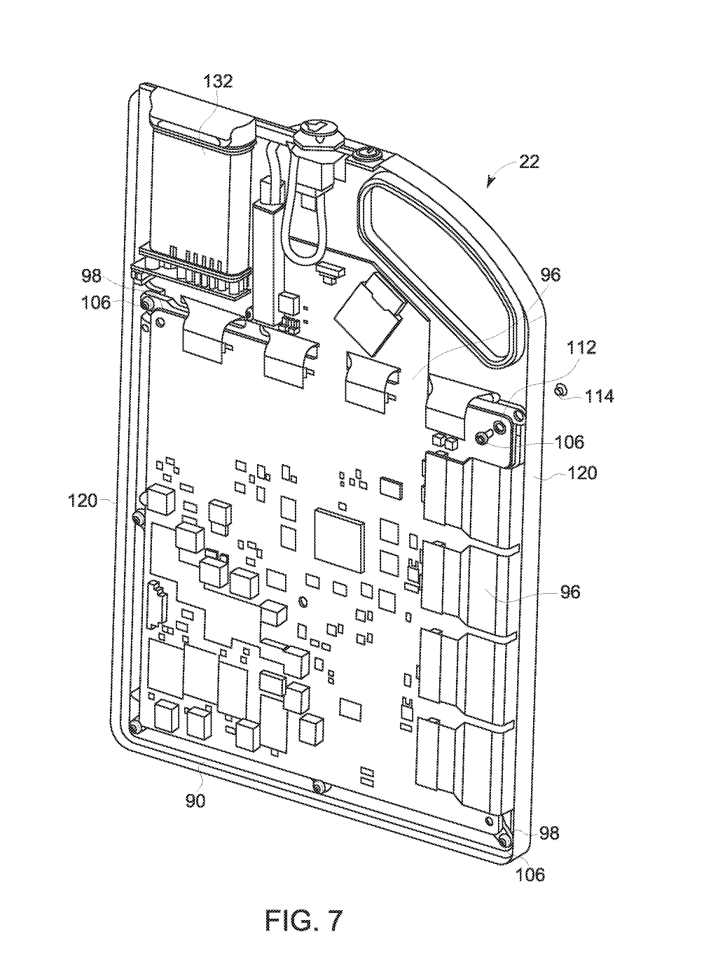

In one embodiment, operating power may be provided to the portable detector 22 via a removable or non-removable battery (see FIG. 7, battery 132) or by a cable (e.g., a tether). Further, in one embodiment, the portable detector 22 may communicate with one or more other components of the system 10, such as the detector controller 26, via a wireless transceiver disposed within the body of the portable detector 22. The portable detector 22 may also include a docking connector 102 that may be used to provide power to the detector 22 and to allow data communication (such as gigabit Ethernet communication) between the detector 22 and other components of an imaging system. While it will be appreciated that FIG. 2 illustrates various components and features that may be present in a variety of portable detector implementations, such as the depicted detector cassette, the implementation of FIG. 2 is provided by way of example only, and is not intended to limit the present disclosure. Indeed, aspects of the present disclosure are equally applicable to a variety of other portable detector implementations, for use in medical imaging and non-medical inspection contexts.

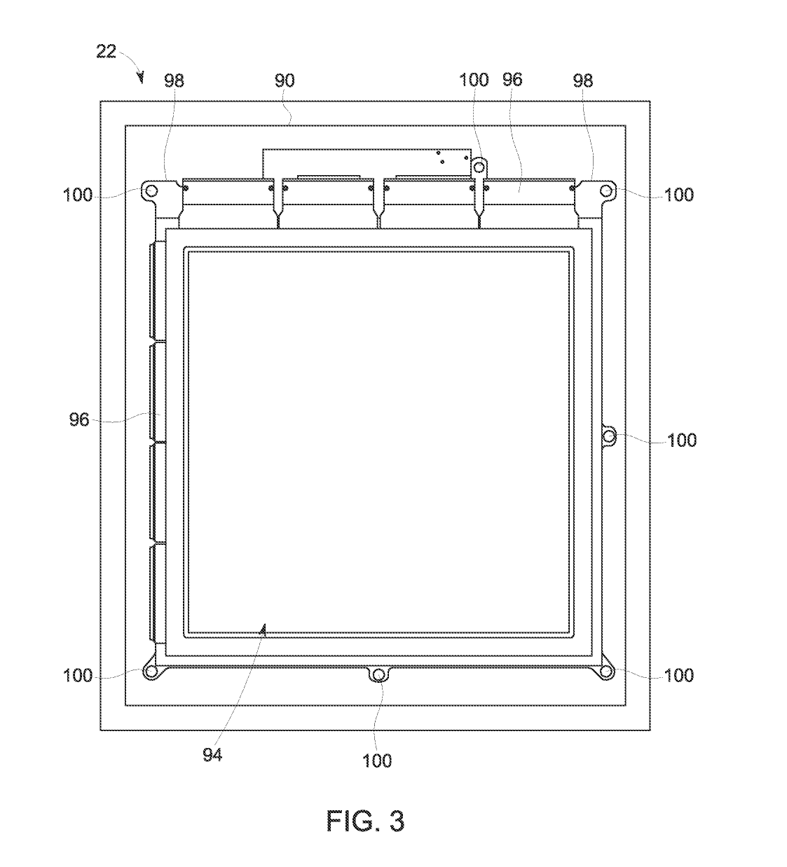

Turning to FIG. 3 a cutaway view of one embodiment of a portable detector 22 is provided. As depicted in this view, the solid-state detector array 94 and the associated readout electronics 96 are mounted on a support plate 98. To simplify explanation, the support plate 98 is discussed herein as being a single piece or layer, though in practice the support plate may include more than one layer, such as a foam backing layer, a backscatter shield, and so forth. The support plate 98, in turn is non-rigidly mounted to or secured to the enclosure 90. In particular, the support plate 98, in the depicted embodiment, includes a plurality of mounting holes 100 which, as discussed herein, can be used in mounting the support plate 98 to the enclosure 90 in a non-rigid manner.

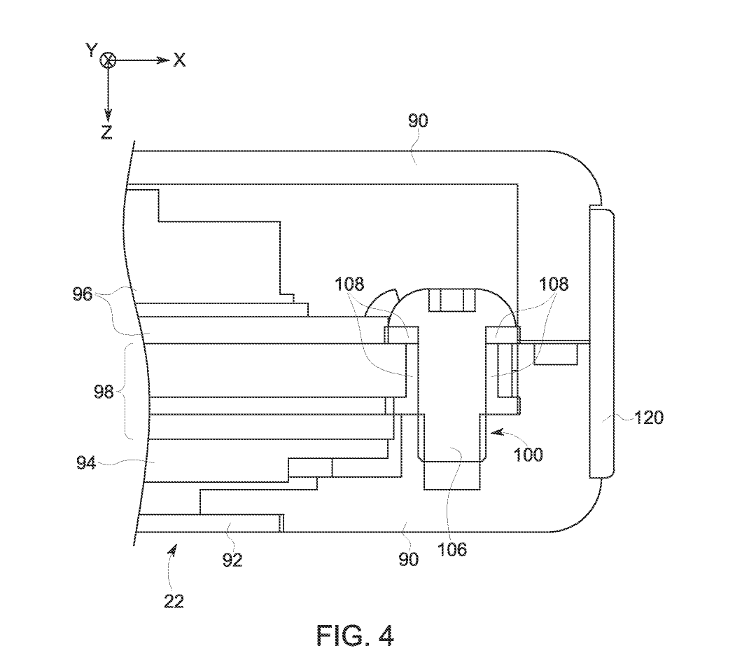

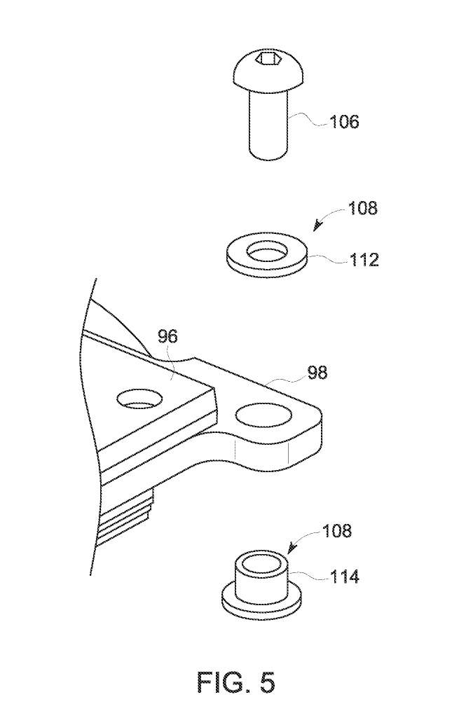

For example, turning to FIGS. 4 and 5, one implementation of a portable detector 22 is depicted in which a fastener 106 (e.g., a screw fastener or other threaded fastener) passes through each mounting hole 100 of the support plate 98 and fastens or secures to a corresponding and complementary securement feature of the enclosure 90 to fasten the support plate 98 to the enclosure 90. In the depicted implementation, an elastomeric intermediary structure 108 passes through the mounting hole 100 and prevents the fastener 106 from directly contacting the support plate 98 which it secures, i.e., the elastomeric structures 108 isolate the support plate 98 from the enclosure 90. As used herein, the term elastomeric material is a material having a Shore A durometer of between 40 to 70, inclusive. The elasticity of the elastomeric structure 108 prevents the fastener 106 from rigidly and fixedly securing the support plate 98 to the enclosure 90. That is, the elasticity of the elastomeric structure 108 allows the support plate 98 to move to some extent (e.g., approximately 1 mm in the x, y, and z directions) with respect to the enclosure 90 in the event of a mechanical shock, such as the portable detector 22 being dropped or hit against a hard surface. As depicted in FIG. 5, in one embodiment, the elastomeric structure 108 may be formed as more than one piece, such as the depicted elastomeric bushing 114 and elastomeric washer 112.

In a further implementation, the portable detector 22 may be provided with an elastomeric strip 120 (i.e., a strip having a Shore A durometer between 40-70 inclusive) around the edge of the enclosure 90. In one such embodiment, an elastomeric strip 120 that is approximately 3 mm to 5 mm (e.g. 4 mm) thick is positioned on the outside edge of the enclosure 90 and either fully surrounds the portable detector 22 on all four edges or partially surrounds the portable detector 22, such as at the corners only. In certain implementations, the elastomeric strip 120 may extend to cover one or both faces of the portable detector 22 at the edges.

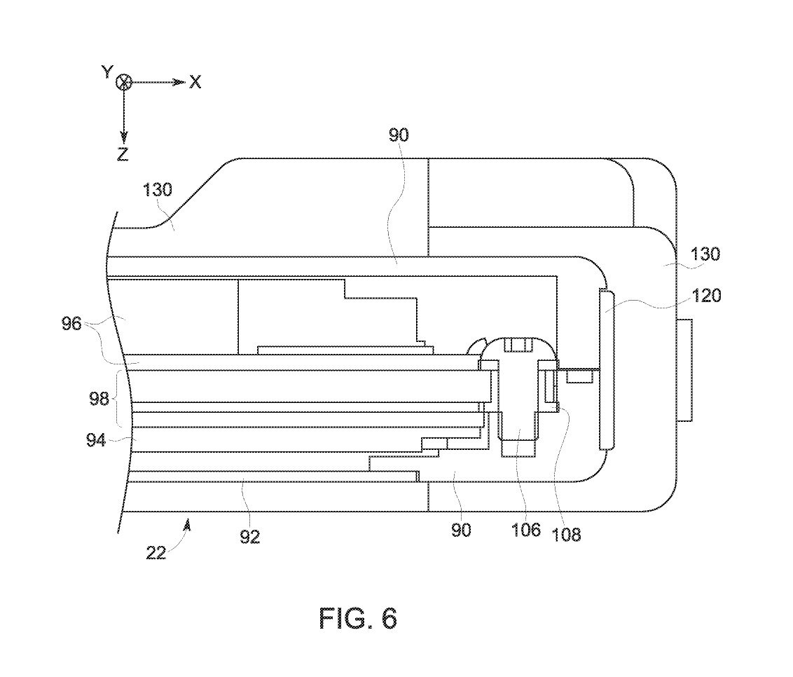

Turning to FIG. 6, in a further embodiment a separate and removable elastomeric cover 130 (i.e., a cover having a Shore A durometer between 40-70 inclusive) may cover all or part of the portable detector 22, such as to provide shock isolation in all directions. In one embodiment, the elastomeric cover is approximately 10 mm to 15 mm (e.g., 12 mm) thick or more). In other embodiments, the elastomeric cover may vary in thickness with respect to different parts of the portable detector 22, such as to be thicker near the edges or corners of the portable detector 22.

In practice, the elastomeric cover 130 may be applied to the portable detector 22 for transport or storage of the detector 22 and may be removed from the portable detector 22 when the portable detector 22 is to be used. In this manner, a suitable (i.e., short) distance between the edge and active area of the portable detector 22 may be maintained. In one embodiment, the elastomeric cover 130 may be stretched over the portable detector 22 on application. In other embodiments, the elastomeric cover may be applied in other manners, such as a clip-on or latch on case, a strapped-on enclosure, a clamshell enclosure and so forth. For example, in certain implementations the elastomeric cover 13 may be assembled over the enclosure 90 from two or more pieces by engaging complementary latches, slotted connectors or clips, fitted connections, or friction fits of the separate constituent pieces of the cover 130. Conversely, the elastomeric cover 130 may be removed, in such implementations, by disengaging the respective connection structures and separating the constituent pieces of the cover 130.

With the foregoing discussion in mind, FIGS. 7-9 depict various examples of possible implementations of a portable detector having shock-absorbing features as discussed herein. For example, FIG. 7 depicts a cut-away perspective view of a portable detector 22 where a support layer 98 is mounted to a housing 90 by fasteners 106 and where elastomeric structures 108 (i.e., elastomeric washers 112 and elastomeric bushings 114) prevent the mounting from being rigid (i.e., allow for some motion of the support layer 98 relative to the housing 90). The embodiment of FIG. 7 also includes an elastomeric strip 120 disposed about a portion of the periphery of the portable detector 22.

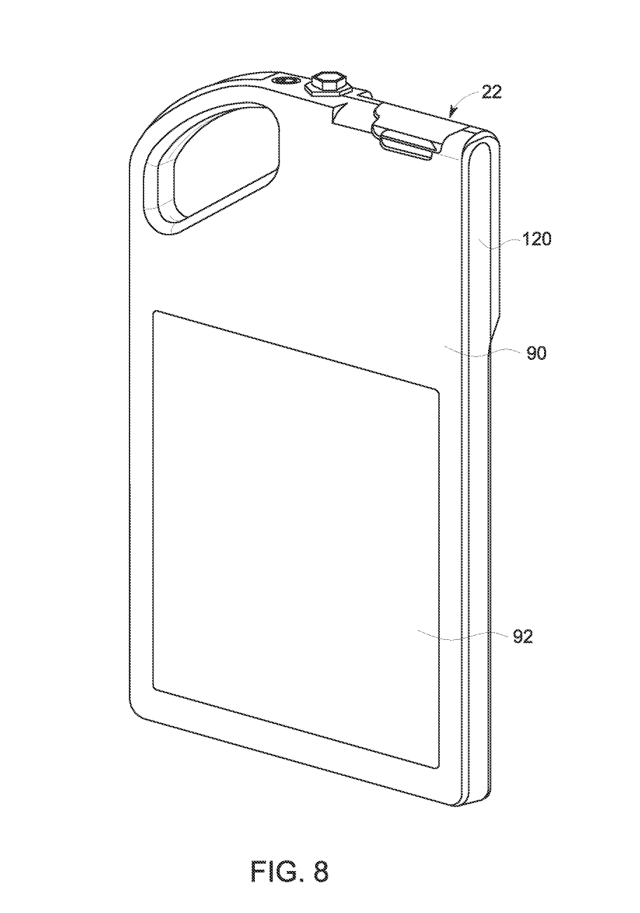

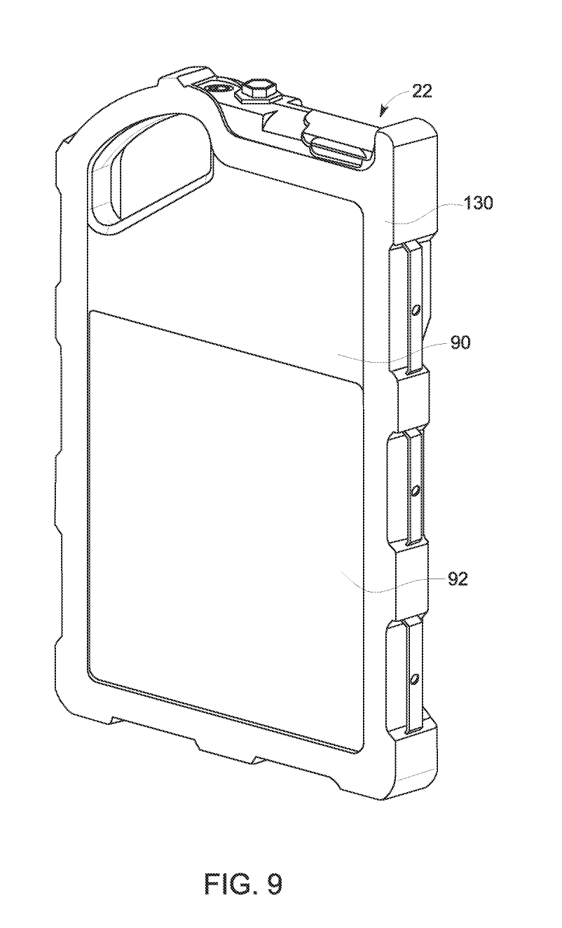

Turning to FIG. 8, a perspective view of the external features of a portable detector 22 is provided. In this example, the portable detector 22 includes an elastomeric strip 120 disposed about a portion of the periphery of the portable detector 22. FIG. 9 depicts the portable detector 22 of FIG. 8 with the addition of an elastomeric cover 130 that extends around a portion of the portable detector 22. In the depicted example, the elastomeric cover 130 provides additional protection and can be removed from the portable detector 22 when not needed, such as during use of the portable detector 22.

This written description uses examples to disclose the present subject matter, including the best mode, and also to enable any person skilled in the art to practice the disclosed subject matter, including making and using any devices or systems and performing any incorporated methods. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A portable radiation detector, comprising:
an enclosure;
a support layer comprising a plurality of mounting holes;
a respective elastomeric structure positioned within each mounting hole;
a respective fastener positioned within each elastomeric structure and secured to the enclosure such that the support layer is fastened to the enclosure;
a detector array mounted on the support layer; and
readout electronics communicatively coupled to the detector array.

2. The portable radiation detector of claim 1, wherein the elastomeric structures allow the support layer to move with respect to the enclosure.

3. The portable radiation detector of claim 1, wherein the elastomeric structures allow the support layer to move approximately 1 mm in at least one direction with respect to the enclosure.

4. The portable radiation detector of claim 1, wherein the fasteners comprise threaded fasteners.

5. The portable radiation detector of claim 1, wherein the elastomeric structures have a Shore A durometer of approximately 40 to approximately 70 inclusive.

6. The portable radiation detector of claim 1, wherein each elastomeric structure comprises an elastomeric washer.

7. The portable radiation detector of claim 1, wherein each elastomeric structure comprises an elastomeric bushing.

8. The portable radiation detector of claim 1, comprising an elastomeric strip disposed around at least a portion of an outer perimeter of the enclosure.

9. The portable radiation detector of claim 1, comprising a removable elastomeric cover covering all or part of the enclosure.

10. A portable radiation detector, comprising:
an enclosure;
an elastomeric strip disposed around at least a portion of an outer perimeter of the enclosure;
a support layer fastened to the enclosure;
a detector array mounted on the support layer;
readout electronics communicatively coupled to the detector array.

11. The portable radiation detector of claim 10, wherein the elastomeric strip is approximately 3 mm to 5 mm thick.

12. The portable radiation detector of claim 10, wherein the elastomeric strip has a Shore A durometer of approximately 40 to approximately 70 inclusive.

13. The portable radiation detector of claim 10, wherein the support layer is non-rigidly fastened to the enclosure.

14. The portable radiation detector of claim 10, wherein the support layer has a range of movement with respect to the enclosure.

15. The portable radiation detector of claim 10, comprising a removable elastomeric cover covering all or part of the enclosure.

16. A cover for a portable radiation detector, comprising:
an elastomeric cover configured to be removably applied to an enclosure of a portable radiation detector, such that the elastomeric cover, when applied, covers at least a portion of an outer perimeter of the enclosure.

17. The cover of claim 16, wherein the elastomeric cover has a Shore A durometer of approximately 40 to approximately 70 inclusive.

18. The cover of claim 16, wherein the elastomeric cover is approximately 10 mm to 15 mm thick.

19. The cover of claim 16, wherein the elastomeric cover varies in thickness.

20. The cover of claim 16, wherein the elastomeric cover is stretched to apply the elastomeric cover to and remove the elastomeric cover from the enclosure.

21. The cover of claim 16, wherein the elastomeric cover is assembled over the enclosure in two or more pieces to apply the elastomeric cover to the enclosure.
